(19) United States
(12) Patent Application Publication
(10) Pub. No.: US 2014/0313280 A1
(43) Pub. Date: Oct. 23, 2014

(54) VIDEO-PHONE DEVICE

(71) Applicant: SANYO Electric Co., Ltd., Moriguchi-shi, Osaka (JP)

(72) Inventors: Shinji Takuno, Tottori (JP); Yasuhiko Nagatani, Tottori (JP); Hideyuki Arimoto, Tottori (JP); Masashi Kakimoto, Tottori (JP); Teruyuki Yorita, Tottori (JP); Nahoko Nada, Tottori (JP)

(73) Assignee: SANYO Electric Co., Ltd., Moriguchi-shi, Osaka (JP)

(21) Appl. No.: 14/361,229

(22) PCT Filed: Oct. 22, 2012
(86) PCT No.: PCT/JP2012/077251

§ 371 Date: May 28, 2014

(30) Foreign Application Priority Data
Nov. 29, 2011 (JP) 2011-260514

(51) Int. Cl. H04L 29/06; H04N 7/14

(52) U.S. Cl. CPC H04L 65/4023; H04N 7/141; H04L 65/1076
USPC 348/14.08

(57) ABSTRACT

A video-phone device which transmits and receives sharable data to and from video-phones belonging to other parties is provided with a communication control means which, upon receiving a reception request or a transmission request for shareable data, assesses whether or not the reception request or the transmission request satisfies predetermined conditions, specifically, whether or not the other party has been stored in a recoding unit as a party to which transmission/reception of sharable data is permitted, and receives sharable data from the other party or transmits sharable data to the other party only when the conditions are satisfied. Thus the video-phone can automatically permit only reception of sharable data from trusted parties on the other end of a communication line, or transmission of sharable data to trusted parties on the other end of a communication line.

### TECHNICAL FIELD

The present invention relates to a video-phone device which is connected to an IP telephone network or the like and which transmits/receives video and audio, and specifically relates to a video-phone device that, upon receiving a share request regarding shared data from a communication-counterpart video-phone device, allows sharing of shared data only for a call counterpart satisfying a predetermined condition.

### BACKGROUND ART

In recent years, a variety of auxiliary services relating to communication have become more widespread with the development of communication infrastructure. For example, telephone devices that can be connected to wide-area communication networks other than a general telephone line, such as an IP telephone network or the Internet, and adapted to receive a variety of services such as data communication services, have become more widespread.

Video-phone services have been brought into practical use as services of such description regarding telephone devices. A user of a video-phone service connects a video-phone device provided with a camera function and an image transmission function to a communication line, and can thereby perform an audio call while transmitting/receiving a captured video image.

Video-phone devices capable of transmitting other image data to the call counterpart in addition to the captured video image have also been developed. For example, Patent Reference 1 (JP-A 2004-228805) below discloses a video-phone function in which it is possible to acquire information such as specific image data relating to a conversation during a video-phone call by multitasking via a network simultaneously with the conversation, and transmit the image data to the counterpart station performing the call.

The above function is achieved by providing a video-phone function means, a data communication function means, and a multi-access function means. The video-phone function means transmits a video image captured by an imaging unit to the counterpart station during a call, and receives, and outputs to a display unit, video transmitted by the counterpart station. The data communication function means connects to a predetermined web page or the like and performs data communication for acquiring text or image display information. The multi-access function means operates the video-phone function means and the data communication function means at the same time. The display information acquired by data communication is transmitted, with the video and the audio, to the counterpart station, and displayed by the counterpart station.

However, in the invention in Patent Reference 1 below, even though it is possible to reference image and other data received from the call counterpart, it is not possible to edit and process the data and return the data to the original call counterpart. In light of the above, the applicant of the present invention previously filed an application for a “video-phone device” in JP-A 2010-292266. In this invention, a video-phone device is provided with an image-editing means for editing and processing image and other data which has been received. It thereby becomes possible to edit, process, and return image and other data received during a call, resulting in the callers being able to understand each other more thoroughly and to have a clear conversation with minimal misunderstanding.

Patent Reference 2 below (JP-A 2004-328525) discloses an IP telephone system in which, when the main device receives a voice message from the call counterpart, the voice message is converted into text data and displayed as a pop-up on a terminal device used by the user, and when, e.g., the user selects the message displayed as a pop-up, the IP telephone system calls back and connects to the originator of the message.

### PRIOR ART REFERENCES

Patent Reference 1: JP-A 2004-228805
Patent Reference 2: JP-A 2004-328525

### DISCLOSURE OF THE INVENTION

### Problems the Invention is Intended to Solve

As in the invention in the above Patent Reference 1 or the above invention by the applicants of the present invention, conventional video-phone devices automatically receive all shared data when receiving shared data such as image data. Therefore, conventional video-phone devices present a problem in that data that is problematic in terms of security may be received, putting the video-phone device itself or personal data and the like stored in the video-phone device at risk.

Meanwhile, requiring a user to perform a confirmation operation every time there is a transmission/reception request as in the invention in the above Patent Reference 2 presents a problem in that operation becomes cumbersome.

Accordingly, an object of the present invention is to make it possible, in a video-phone device, to automatically allow only the reception of shared data from a trusted call counterpart or transmission of shared data to a trusted call counterpart so as to prevent reception of shared data that is problematic in terms of security or transmission of confidential shared data, and thereby obviate the need for a cumbersome operation, improve security, and enhance convenience.

### Means for Solving the Abovementioned Problems

In order to resolve the above problem, a video-phone device according to an embodiment is a video-phone device for exchanging shared data with a call counterpart; the video-phone device comprises communication control means for determining, once a reception request or a transmission request regarding said shared data has been received, whether or not said reception request or transmission request satisfies a predetermined condition, and receiving said shared data from said call counterpart or transmitting said shared data to said call counterpart only when said predetermined condition is satisfied.

According to a second aspect of the present invention, the video-phone device is further provided with a recording unit for recording call counterparts with which the exchange of said shared data is allowed by said video-phone device, said communication control means receives said shared data from said call counterpart or transmits said shared data to said call counterpart only when, as said predetermined condition, the call counterpart which has transmitted said reception request or transmission request is a call counterpart with which the exchanging of said shared data is allowed.

According to a third aspect of the present invention, the video-phone device is further provided with registering means for registering the call counterparts in said recording unit, said registering means registers, as a call counterpart with which the exchanging of said shared data is allowed, a call counterpart with which said communication control means has exchanged said shared data.

According to a fourth aspect of the present invention, said communication control means receives said shared data from said call counterpart or transmits said shared data to said call counterpart only when, as said predetermined condition, the call counterpart which has transmitted the reception request or the transmission request regarding said shared data is a billing party.

According to a fifth aspect of the present invention, said communication control means checks with the user whether or not to allow transmission or reception of said shared data in a case where the reception request or the transmission request regarding said shared data does not satisfy said predetermined condition.

According to a sixth aspect of the present invention, the communication control means allows reception of said shared data from said call counterpart or transmission of said shared data to said call counterpart in a case where, once the exchanging of shared data has been allowed during the same call, a transmission request or a reception request regarding said shared data is again received.

### Effect of the Invention

The present invention has the following beneficial effects. According to an embodiment of the video-phone device, when a reception request or a transmission request regarding the shared data is received, the communication control means determines whether or not the reception request or the transmission request satisfies a predetermined condition. The shared data is received from the call counterpart or transmitted to the call counterpart if the predetermined condition is satisfied. It is thereby possible to selectively respond only to a trusted request satisfying the predetermined condition. There is no need for the user to perform an operation of some sort to perform a confirmation input in response to a request satisfying the predetermined condition, making it possible to omit cumbersome operations.

According to an embodiment of the video-phone device, the shared data is received from the call counterpart or transmitted to the call counterpart only when the reception request or the transmission request is from a call counterpart with which exchanging of shared data recorded in the recording unit is allowed. It is thereby possible to automatically allow, through merely registering a call counterpart with which the exchanging of shared data is allowed, the exchanging of shared data from and to a registered user, and to enhance security and convenience.

According to an embodiment of the video-phone device, a registering means registers, as a call counterpart with which the exchanging of shared data is allowed, a call counterpart with which the communication control means has exchanged the shared data. It is thereby possible to automatically allow exchanging of shared data when a transmission/reception request regarding the shared data is received from a call counterpart with which the exchanging of shared data has previously been allowed, and omit the cumbersome operation of the user performing an operation of some sort to perform a confirmation input.

According to an embodiment of the video-phone device, the shared data is received from the call counterpart or transmitted to the call counterpart in response only to an instance in which the call counterpart which has transmitted the reception request or the transmission request regarding the shared data is a billing party. It is thereby possible to prevent the shared data from being transmitted or received and the user being billed even though the user has not allowed sharing.

According to an embodiment of the video-phone device, whether nor not the transmission or reception of the shared data is allowed is checked with the user if the reception request or the transmission request regarding the shared data does not satisfy the predetermined condition. It is thereby possible to ask the user to allow exchanging of shared data that may be problematic in terms of security or that may lead to problems in terms of billing. Therefore, it is possible to improve security, ask the user to perform a confirmation input only when genuinely necessary, and minimize cumbersome operations.

According to an embodiment of the video-phone device, exchanging of the shared data is automatically allowed without the user being asked to perform a confirmation input if, once exchanging of shared data has been allowed during a call, a transmission/reception request is received again. It is thereby possible to minimize cumbersome operations at the same time as improving security.

### BRIEF DESCRIPTION OF THE DRAWINGS

FIG. 1 is a block diagram showing the configuration of a communication system 1 including a video-phone device according to an embodiment;

FIG. 2 is an interior block diagram showing the configuration of a video-phone device according to the embodiment;

FIG. 3 is a flow chart showing the action in a process for sharing shared data according to the embodiment;

FIG. 4 is a display screen at the start of a call of a user-side video-phone device and a video-phone device used by the call counterpart for the video-phone device according to the embodiment;

FIG. 5 shows the display screen of the video-phone device in FIG. 4, and shows the state in which an image data edit screen is displayed by the communication-counterpart video-phone device;

FIG. 6 shows the display screen of the video-phone device in FIG. 4, and shows the state in which image data is shared between the communication-counterpart video-phone device and the user-side video-phone device;

FIG. 7A shows the display screen of the user-side video-phone device, and shows a query screen being displayed when a share request is received from the communication-counterpart video-phone device; and

FIG. 7B shows the display screen of the communication-counterpart video-phone device, and shows an example of the display screen in the user-side video-phone device when the share request is rejected.

### BEST MODE FOR CARRYING OUT THE INVENTION

The best mode for carrying out the present invention will now be described in detail with reference to an embodiment and the accompanying drawings. The embodiment indicated below is a description of an example of a video-phone device embodying the technical concept of the present invention. The embodiment is not intended to limit the scope of the present invention to the video-phone device; it can be equally applied to another video-phone device without departing from the technical concept indicated in the claims.

### Embodiment

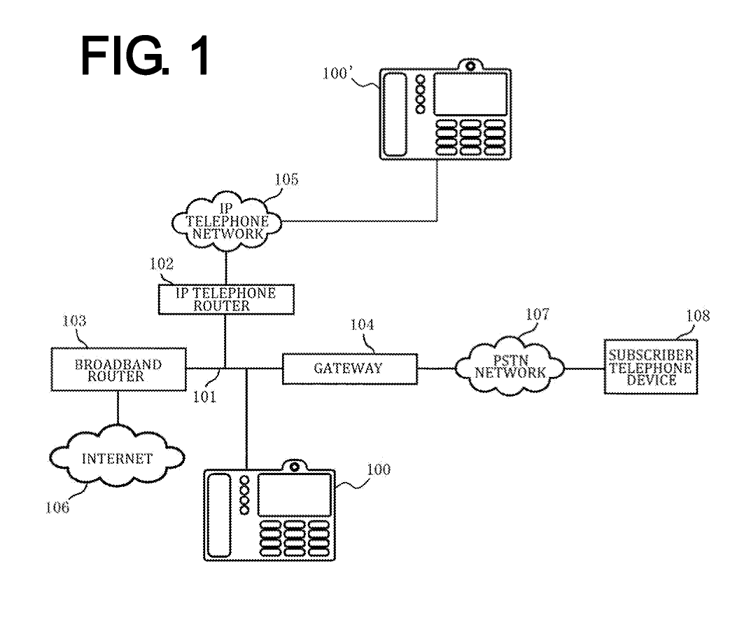

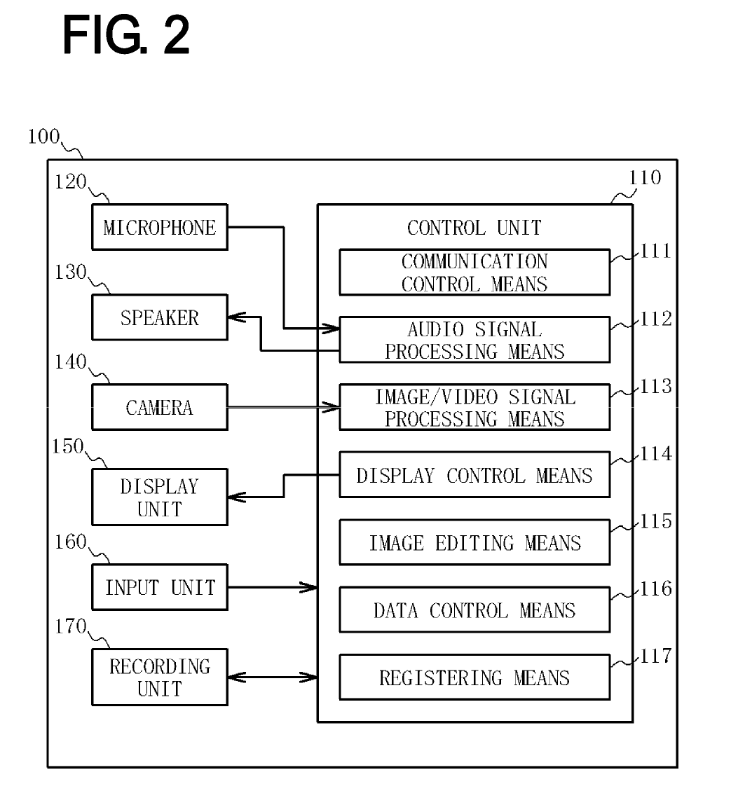

With reference to FIG. 1, the system includes at least a video-phone device 100, a wired LAN 101, an IP telephone router 102, a broadband router 103, a gateway 104, an IP telephone network 105, the Internet 106, a public switched telephone network (PSTN) 107, and a subscriber telephone device 108.

The video-phone device 100 according to an embodiment is connected to the wired LAN 101, and the wired LAN 101 is connected via the IP telephone router 102 to the IP telephone network 105, via the broadband router 103 to the Internet 106, and via the gateway 104 to the PSTN network 107, thereby enabling communication. The interior structure of the communication system 1 will be described in detail further below.

10BASE-T (standardized as IEEE802. 3i), 100BASE-TX (standardized as IEEE802.3u), or the like can be used as the wired LAN 101.

The IP telephone router 102 and the broadband router 103 are network relay devices for interconnecting a plurality of IP networks. Specifically, [the IP telephone router 102 and the broadband router 103] transfer data upon analyzing a protocol for a part of a network layer (third layer) and a transport layer (fourth layer) in an Open Systems Interconnection (OSI) model.

In the present example, the IP telephone router 102 have a role of interconnecting the two IP networks comprising the wired LAN 101 and the IP telephone network 105. The broadband router 103 has a role of interconnecting the two IP networks consisting of the wired LAN 101 and the Internet 106.

The gateway 104 is a protocol converter for interconnecting networks having different protocol systems. The gateway 104 interconnects, e.g., the wired LAN 101 and the PSTN network 107 and performs a signal conversion using a signaling protocol such as SIP, thereby enabling communication between the networks.

The IP telephone network 105 is a communication network using Voice-Over Internet Protocol technology (VOIP) for a part or all of a telephone network. A “broadband line” such as Fiber To The Home (FTTH) or an Asymmetric Digital Subscriber Line (ADSL) is used for the communication line. Although a plurality of video-phone devices 100′ are connected to the IP telephone network 105, only one is shown in FIG. 1 for the sake of simplicity.

VOIP is a technology in which audio is compressed using a variety of encoding formats, and then divided into packets and transmitted in real time over an IP network. It is thereby possible for the IP telephone network 105 to provide services such as a video-phone service for transmitting/receiving an image in addition to a voice call service.

The Internet 106 is a wide-area communication network built by interconnecting networks via communication protocols. A variety of computer networks of varying sizes are interlinked to build a global communication network. For the communication protocol, TCP/IP is primarily used as the standard protocol.

The PSTN network 107 is a general subscriber telephone line network, and is used to carry voice calls by connecting the subscriber telephone device 108 to a terminal and connecting to the call counterpart using a line-switching system. The subscriber telephone device 108 is a telephone device used by a telephone subscriber to carry voice calls with another subscriber telephone device connected to a PSTN network using the PSTN network 107, or with a video-phone device connected to the wired LAN 101 or the IP telephone network 105.

Next, a description will now be given for a video-phone device 100 according to an embodiment. The video-phone device 100 is provided with a control unit 110, a microphone 120, a speaker 130, a camera 140, a display unit 150, an input unit 160, and a recording unit 170

The control unit 110 is a microprocessor including a CPU, a RAM, and a ROM. A control program recorded in the RAM or the ROM is executed by the CPU, whereby the action of the means described further below is controlled and supervised.

The control unit 110 is provided with communication control means 111, audio signal processing means 112, image/video signal processing means 113, display control means 114, image editing means 115, data control means 116, and registering means 117.

The communication control means 111 performs communication control when the video-phone device 100 communicates with another video-phone device (video-phone devices 100′ in FIG. 1). The control includes that relating to signaling, data exchanging, and a data sharing process.

Signaling includes generation, establishment, and disconnection of a communication session. Specifically, signaling includes: establishing, when the user operates an input unit 160 and inputs a telephone number or the like, a connection with a SIP server (not shown) connected to the IP telephone network 105, obtaining the location information regarding the communication-counterpart video-phone device 100′, calling the communication-counterpart video-phone device 100′, and establishing a communication path if the call counterpart responds; and transmitting a session disconnection message or a similar message and ending the session when the call is finished.

Control relating to exchanging of data includes IP packetizing, in which audio data, video data, and image data are divided into packets, transmission of IP packets, and reception and assembly of IP packets in which packets received via the wired LAN 101 are rearranged into the correct sequence and the actual data portion is extracted and assembled.

When data is transmitted as packets, a header indicating the origin, address, sequence, transmission time, and usage (IP telephone audio data, video data, or image data) is affixed to each data items divided into predetermined data lengths. The received packet is assembled in the correct sequence for each of the audio, video, and image through referencing the header portion, and outputted to the audio signal processing means 112 and the image/video signal processing means 113.

With regards to the control relating to a data sharing process, a share request is communicated to the communication-counterpart video-phone device 100′ on the basis of a command issued by the user. In other words, a shared data reception request is transmitted to the communication-counterpart video-phone device 100′ when shared data is to be transmitted to the communication-counterpart video-phone device 100′, and a shared data transmission request is transmitted to the communication-counterpart video-phone device 100′ to request the communication-counterpart video-phone device 100′ to transmit the shared data.

Upon receiving a share request from the communication-counterpart video-phone device 100′, whether or not the share request satisfies a predetermined condition is determined, and sharing is allowed, i.e., reception of shared data from the communication-counterpart video-phone device 100′ or transmission of shared data to the communication-counterpart video-phone device 100′ is allowed, only if the predetermined condition is satisfied.

The audio signal processing means 112 performs A/D conversion on the audio inputted from the microphone 120, then compresses the converted audio using an audio codec, and outputs the compressed data to the communication control means 111. The audio signal processing means 112 also decompresses the audio data assembled by the communication control means 111 using an audio codec, then D/A converts the decompressed audio data and outputs the result from the speaker 130.

The image/video signal processing means 113 is provided with a video codec. The image/video signal processing means 113 compresses the video image captured by the camera 140, and outputs the compressed data to the communication control means 111. The video data assembled by the communication control means 111 is decompressed and outputted to the display control means 114, by the image/video signal processing means 113. The image/video signal processing means 113 is also provided with an image codec. The image/video signal processing means 113 decompresses the image data assembled by the communication control means 111 and loads the decompressed data to a memory (RAM of the control unit 110).

The display control means 114 converts (expands, shrinks, arranges images in a row, etc.) the video data outputted from the camera 140 and the image/video signal processing means 113 and the image data loaded into the memory (RAM of the control unit 110) into a predetermined format that can be displayed on the display unit 150, loads the result into the video memory (not shown) of the display unit 150, and causes the display unit 150 to display the result.

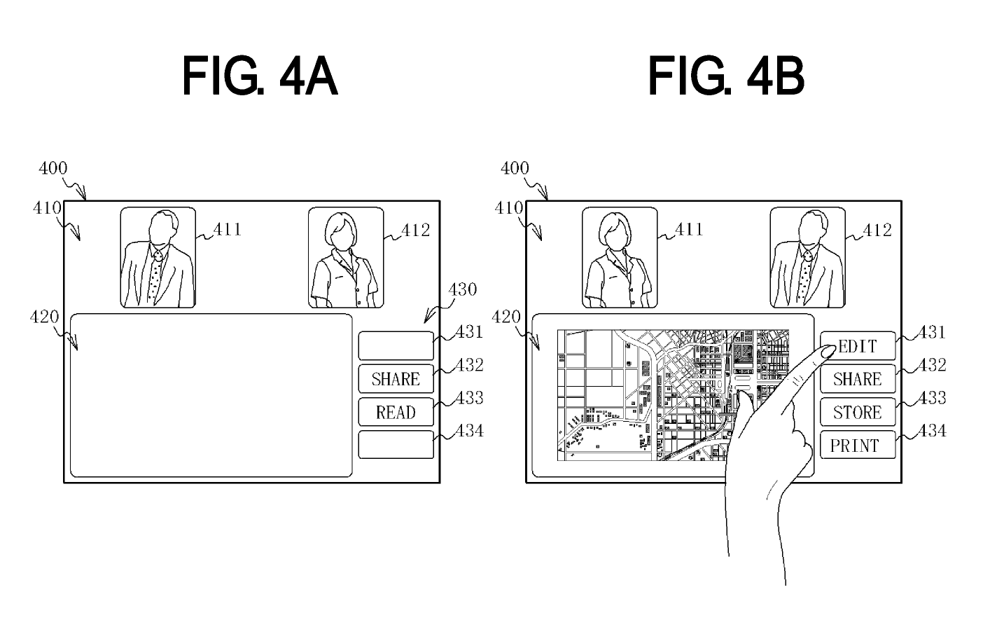

For example, the display control means 114 divides the display screen of the display unit 150 horizontally into two as shown in FIG. 4. On the upper side, the video image captured by the camera 140 and the video image received from the call counterpart are displayed next to each other on the display unit 150. On the lower side, a region for displaying data to be shared is provided. The display method is not limited to that above, and a variety of formats are possible.

The image editing means 115 is used to edit the image data according to an operation performed by the input unit 160. Editing of the image data includes, e.g., drawing a line, inserting text, inputting hand-drawn items, or inserting a shape.

The data control means 116: monitors data received by the communication control means 111 and thereby determines that an image has been received by the communication-counterpart video-phone device 100′, and upon receiving an image data, loads the image data into a memory (RAM of the control unit 110); takes in image data from the recording unit 170 and loads the image data into the memory (RAM of the control unit 110); transmits the image data loaded into the memory (RAM of the control unit 110) through the communication control means 111 to the call counterpart or a server connected to the Internet 106 in response to a shared data transmission request; commands, if a printer is connected to the video-phone device 100, the printer to perform an output; and stores [data] in the recording unit 170.

The registering means 117 records, in an address book recorded in the recording unit 170, the telephone number, the name, and information representing whether shared data can be shared, regarding call counterparts, in an associated manner. A further arrangement is possible in which, when shared data is transmitted or received, the setting for the information representing whether shared data can be shared regarding a call counterpart is rewritten from “sharing not allowed” to “sharing allowed” and recorded.

Audio collected by the microphone 120 is converted into an audio signal and outputted to the audio signal processing means 112. The audio signal outputted from the audio signal processing means 112 is converted into audio and outputted by the speaker 130. The microphone 120 and the speaker 130 can be provided in a fixed manner to the video-phone device 100, or can be a headset. A headset will obviate the need for the microphone 120 to be held manually, enhancing convenience.

The camera 140 captures the image of a subject located in front of the camera 140 while a call is being made by the video-phone device 100. Normally, the user is located in front of the video-phone device 100; therefore, the camera 140 captures the user as the subject. The captured video image is outputted to the image/video signal processing means 113.

The display unit 150 is a liquid crystal display unit, and displays a video or still image loaded by the display control means 114 to the video memory of the display unit 150.

The input unit 160 takes the form of a touch panel formed integrally with the display unit 150. The user touches the portion corresponding to an input icon displayed on the display unit 150 and thereby performs an input operation. For example, when a call is to be made, a numeric keypad for inputting the telephone number is displayed on the input unit 160, and the user is able to press, using the finger, the corresponding portions of the numeric keypad to input the number. The input unit 160 is not limited to that described above; it may constitute keys or buttons formed on one portion of a casing forming part of the video-phone device 100.

The recording unit 170 includes a memory internally provided in the video-phone device 100 or a memory that can be connected/detached such as flash memory. The recording unit 170 records data such as image data, text, data, and browser information. Data of such description is transmitted, as shared data, to the communication-counterpart video-phone device 100′ or a server connected to the Internet 106 when a command has been issued by the user. In addition, the recording unit 170 stores shared data received from the communication-counterpart video-phone device 100′ and shared data acquired from a server connected to the Internet 106.

The recording unit 170 also records an address book in which the telephone number, the name, and information representing whether shared data can be shared, regarding a plurality of call counterparts, in an associated manner. The information representing whether shared data can be shared may be set in advance by the user using the registering means 117. An arrangement is also possible in which a call counterpart is registered as “sharing not allowed”, or the setting may be changed so that the call counterpart is [registered as] “sharing allowed” once sharing has been allowed.

Sharing of data refers to a state in which image data, notepad and other text data, or browser and other application data (hereafter referred to as shared data) is transmitted to the communication-counterpart video-phone device 100′ and the shared data is received by the video-phone device 100′, or the above shared data received from the communication-counterpart video-phone device 100′ is received by the video-phone device 100, thereby making it possible for the same image data, text data, and application to be referenced using the display unit 150 in both the video-phone device 100 used by the user and the communication-counterpart video-phone device 100′.

Sharing of data also includes, in addition to exchanging of shared data through one-to-one communication between the video-phone device 100 and the communication-counterpart video-phone device 100′, exchange, or operation, of shared data through a server connected to the Internet 106. For example, an arrangement is possible in which shared data is transmitted from the video-phone device 100 to the server connected to the Internet 106 and the shared data is stored, and the server can be accessed from the communication-counterpart video-phone device 100′ to receive or operate the shared data. An arrangement is also possible in which the shared data transmitted from the communication-counterpart video-phone device 100′ to the server can be accessed from the local video-phone device 100 and received or operated and thereby shared.

A share request refers to transmitting a reception request regarding the shared data to the communication-counterpart video-phone device 100′ when shared data in the recording unit 170 of the video-phone device 100 or shared data temporarily stored in a device such as the RAM of the control unit is transmitted to the communication-counterpart video-phone device 100′. A share request also refers to transmitting, when the shared data is held by the communication-counterpart video-phone device 100′, a message to the communication-counterpart video-phone device 100′ requesting the shared data to be transmitted to the video-phone device 100 (i.e., a transmission request).

A share request also includes, when data is shared through a server (not shown) connected to the Internet 106, transmitting the shared data in the video-phone device 100 to the server and transmitting a reception request regarding the shared data to the communication-counterpart video-phone device 100′.

A share request also includes, when the shared data is held by the communication-counterpart video-phone device 100′, requesting the communication-counterpart video-phone device 100′ to transmit the shared data to the server connected to the Internet 106.

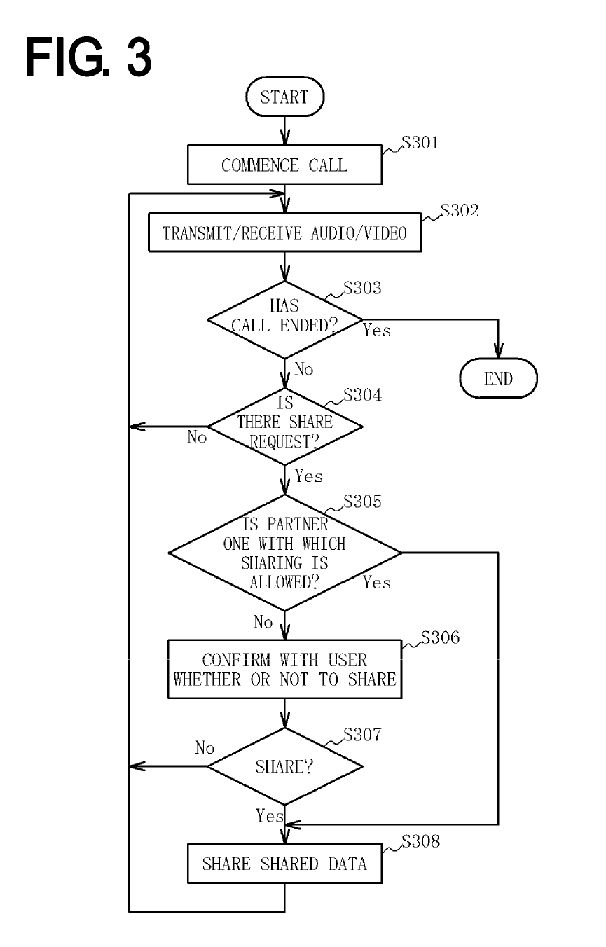

A description will now be given for the process for sharing shared data in the video-phone device 100 according to an embodiment, with reference to FIGS. 3 through 7.

In step S301, the user operates the input unit 160 of the video-phone device 100 and inputs the telephone number of the communication-counterpart video-phone device 100′ connected to the IP telephone network 105. Alternatively, the user operates the input unit 160, accesses the address book recorded in the recording unit 170, and performs an operation to select the call counterpart. Then, the communication control means 111 searches the call counterpart on the basis of the inputted telephone number or the information regarding the selected call counterpart and accesses the communication-counterpart video-phone device 100′. If the call counterpart responds, a communication session is established and a call is commenced. The call may be initiated by the user-side video-phone device 100; alternatively, the communication-counterpart video-phone device 100′ may access the user-side video-phone device 100, and the user responding to the callout results in the communication session being established and the call being commenced.

In step S302, exchange of audio and video is performed between the video-phone device 100 and the communication-counterpart video-phone device 100′. Specifically, audio inputted from the microphone 120 is A/D-converted by the audio signal processing means 112 and compressed by an audio codec. Video images captured by the camera 140 is displayed by the display control means 114 on the display unit (150) and compressed by a video codec provided to the image/video signal processing means 113. Each of the compressed audio data and video data is divided by the communication control means 111 into IP packets and transmitted to the wired LAN 101, and the transmitted audio data and video data are played back or displayed by the communication-counterpart video-phone device 100′.

When the audio data and the video data received as IP packets from the communication-counterpart video-phone device 100′ are received by the user-side video-phone device 100, the communication control means 111 sorts the IP packets by type according to whether the data is audio data, video data, or the like, extracts the actual data portion from the divided packets, and assembles [the data] in sequence. Next, the audio data is decompressed by an audio codec of the audio signal processing means 112, then D/A-converted, outputted to the speaker 130, and outputted as audio. The video data is decompressed by a video codec provided to the image/video signal processing means 113, outputted to the display control means 114, and edited to a format that can be displayed by the display unit 150 and displayed by the display control means 114.

FIG. 4 shows an example of the display screens 400 of the user-side video-phone device 100 and the communication-counterpart video-phone device 100′ when a call has been commenced and audio and video are being transmitted and received in the video-phone device according to the embodiment. The display screen of the user-side video-phone device 100 is shown in FIG. 4A and the display screen of the communication-counterpart video-phone device 100′ is shown in FIG. 4B.

Each of the display screens is provided with a video image region 410 and a shared data display region 420. In FIG. 4, the video image region 410 is provided on the upper side of the display screen 400 and the shared data display region 420 is provided on the lower side of the display screen 400. The regions can be provided so as to be divided horizontally as shown in FIG. 4, or can be provided so as to be divided vertically.

In the display screen 400 of the user-side video-phone device 100, the video image region 410 is provided with a self-station video image region 411 for displaying a video image captured by the user-side video-phone device 100 and a counterpart station video image region 412 for displaying a video image captured by the communication-counterpart video-phone device 100′. In FIG. 4A, the face of the user making a call using the user-side video-phone device 100 is displayed in the self-station video image region 411, and the face of a call counterpart making a call using the communication-counterpart video-phone device 100′ is displayed in the counterpart station video image region 412.

In the display screen of the communication-counterpart video-phone device 100′ displayed in FIG. 4B, the face of a person using the communication-counterpart video-phone device 100′ is displayed in the self-station video image region 411, and the face of the user using the user-side video-phone device 100 is displayed in the counterpart station video image region 412.

A variety of menu icons 430 are displayed on the right side of the shared data display region 420. The menu icons 430 include an “edit” icon 431, a “share” icon 432, a “read” or “store” icon 433, and a “print” icon 434. In FIG. 4A, the “edit” icon 431 and the “print” icon 434 are unnecessary because the shared data has not yet been read, and are therefore not shown.

In step S303, the communication control means 111 determines whether or not to end the call on the basis of an operation performed by the user on the input unit 160 or on the basis of a session disconnection notification from the communication-counterpart video-phone device 100′. When it is determined that the call is to be ended, the functions of the microphone 120, the speaker 130, and the camera 140 are discontinued and the call process is ended.

When it is determined in step S303 that the call is not to be ended, the flow proceeds to the following step (step S304), and the communication control means 111 determines whether or not a share request regarding the shared data has been received from the communication-counterpart video-phone device 100′.

If, in step S304, a share request regarding the shared data is not received from the communication-counterpart video-phone device 100′, the flow returns to the process of step S302, and the processes from step S302 to step 304 continue to be performed until the call ends.

FIG. 4B shows a state in which the call counterpart accesses the image data or other shared data stored in the communication-counterpart video-phone device 100′ and the shared data is displayed in the shared data display region 420. In FIG. 4B, the shared data is a map image.

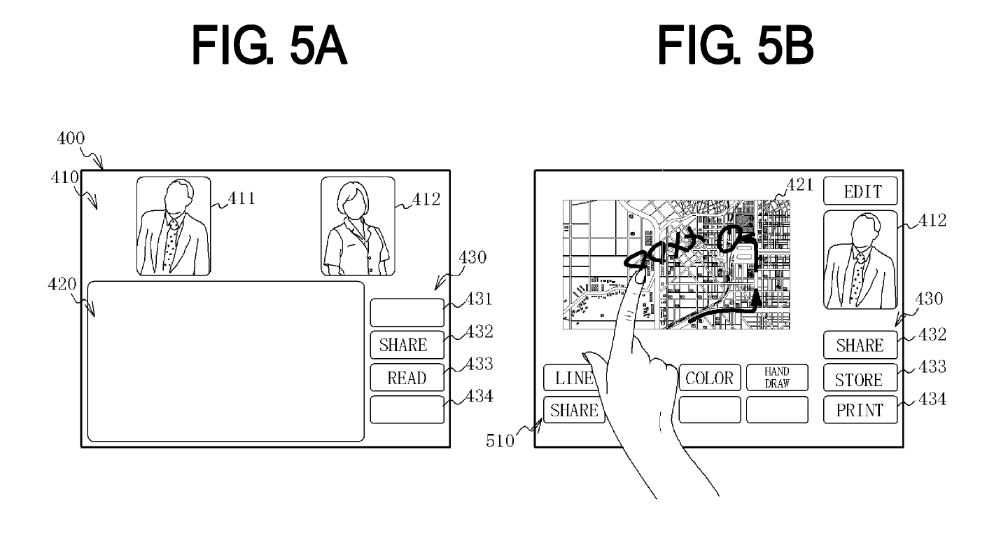

When, in FIG. 4B, the call counterpart selects the “edit” icon 431, an image data edit screen as shown in FIG. 5B is displayed. The edit screen includes a counterpart station video image region 412 provided to the upper right as with the instance shown in FIG. 4, image data 421 displayed on the upper side, a variety of menu icons 430 provided on the right side of the screen, and edit menu icons 510 displayed on the lower side.

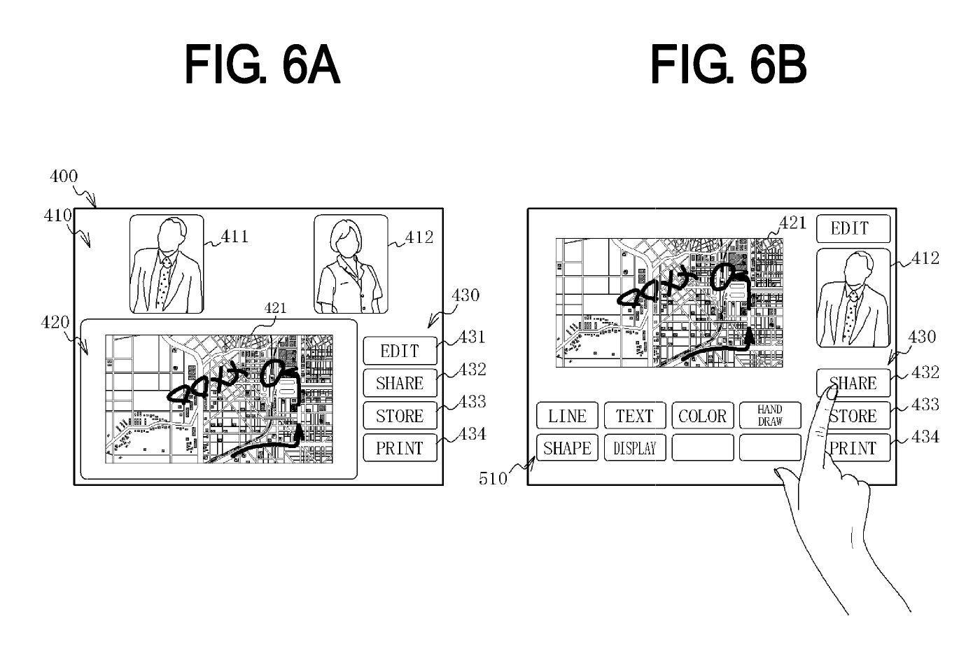

The edit menu icons 510 include, e.g., a “line” icon for drawing a line, a “text” icon for inputting text (see FIG. 6B), a “color” icon for changing the color of inputted lines and text, a “hand-draw” icon for drawing freehand, a “shape” icon for inserting a shape, and a “display” icon for performing a full-screen or a divided display (see FIG. 6B, etc.).

When the call counterpart performs an operation to select an edit menu icon displayed on the edit screen on FIG. 5B to select an edit method and then uses a finger to touch the image data 421 and thereby draws, e.g., a line, a freehand shape, or a shape, in response, the image editing means 115 of the communication-counterpart video-phone device 100′ performs a corresponding edit process on the image data. When the “text” icon is selected, a keyboard or other input icons are displayed and text input performed by the user is received.

While the call counterpart is performing editing as shown in FIG. 5B, nothing is displayed in the shared data display region 420 on the display screen 400 of the user-side video-phone device 100 as shown in FIG. 5A.

When, as shown in FIG. 6B, the call counterpart selects the “share” icon 432, the communication control means 111 of the communication-counterpart video-phone device 100′ transmits a share request regarding the shared data such as the edited image data to the user-side video-phone device 100.

When, in step S304, it is determined that the user-side video-phone device 100 has received a share request regarding the shared data from the communication-counterpart video-phone device 100′, the flow proceeds to the process in step S305, and the communication control means 111 of the user-side video-phone device 100 determines whether or not the received share request satisfies a predetermined condition. The condition is whether, upon the communication control means 111 referencing the address book recorded in the recording unit 170, the call counterpart is registered as a call counterpart for which sharing is allowed, and whether the call counterpart which has transmitted a share request regarding shared data is a billing party.

An arrangement is also possible in which auxiliary information indicating whether sharing has occurred in the past is recorded, in association with the call counterparts, in the address book recorded in the recording unit 170, and the share request is determined to satisfy the predetermined condition if sharing has occurred in the past. An arrangement is also possible in which if shared data has already been shared in response to a share request during the same call, it is determined that the predetermined condition is satisfied, even after sharing of the shared data has temporarily ended.

In step S305, if it is determined that the share request regarding shared data from the communication-counterpart video-phone device 100′ satisfies a predetermined condition, the flow proceeds to the process in step S308, and the communication control means 111 of the user-side video-phone device 100 transmits [a notification] approving a share request regarding the shared data from the communication-counterpart video-phone device 100′. In response, the communication-counterpart video-phone device 100′ transmits the shared data, i.e., in the present embodiment, the edited image data, to the user-side video-phone device 100, the communication control means 111 of the user-side video-phone device 100 receives the image data, the data control means 116 loads the shared data into a memory, the display control means 114 displays the shared data on the display unit 150, and the flow returns to the process in step S302.

The display screen of the user-side video-phone device 100 is shown in FIG. 6A. The edited image data 421, which is the shared data received from the communication-counterpart video-phone device 100′, is displayed on the shared data display region 420 on the display screen 400 in FIG. 6A.

It then possible to retrieve and execute a process, performed on the image data, corresponding to each menu [item] by selecting a menu icon 430 on the right side of the screen.

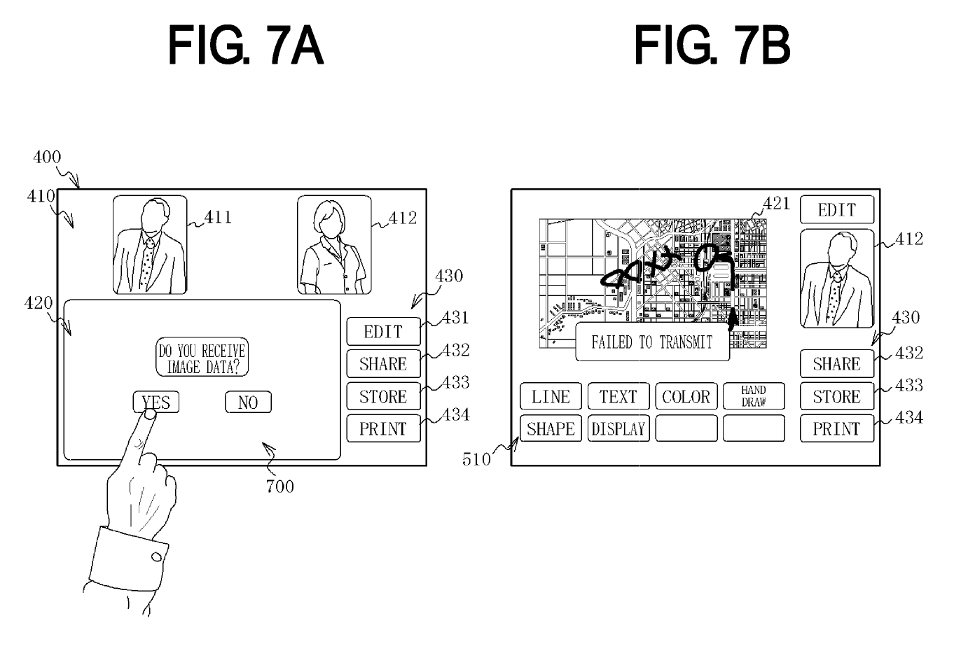

If, in step S305, it is determined that the share data of the shared data from the communication-counterpart video-phone device 100′ does not satisfy the predetermined condition, the flow proceeds to the process in step S306, and the communication control means 111 of the user-side video-phone device 100 issues a command to query the user as to whether or not to allow sharing of the shared data. This is performed by the communication control means 111 outputting a command to the display control means 114 and displaying a query screen 700 such as that shown in FIG. 7A on the display unit 150.

In step S307, the communication control means 111 determines whether or not the user has allowed sharing of the shared data. This can be performed by establishing whether or not the user, upon operating the input unit 160, has performed an input to select an option allowing the shared data to be shared. When it is determined that the user has allowed sharing of the shared data, the flow proceeds to step S308, and the communication control means 111 of the user-side video-phone device 100 transmits, to the communication-counterpart video-phone device 100′, [a notification] approving the share request regarding the shared data from the communication-counterpart video-phone device 100′. In response, the communication-counterpart video-phone device 100′ transmits the shared data, i.e., in the present embodiment, the edited image data, to the user-side video-phone device 100, the communication control means 111 of the user-side video-phone device 100 receives the image data, the data control means 116 loads the shared data into a memory, the display control means 114 displays the shared data on the display unit 150, and the flow returns to the step in step S302.

If, in step S307, the communication control means 111 determines that the user has not allowed sharing of the shared data, the communication control means 111 of the user-side video-phone device 100 transmits, to the communication-counterpart video-phone device 100′, [a notification] rejecting sharing, and the flow returns to the process in step S302. Upon receiving the notification, the communication-counterpart video-phone device 100′ displays a message, such as that shown in FIG. 7B, indicating that sharing has failed. In FIG. 7B, a message stating “transmission failed” is displayed.

As described above, in the present invention, if a share request regarding shared data is from a video-phone device of a call counterpart registered in the recording unit as a counterpart for which sharing of shared data is allowed, the shared data is automatically received by the user-side video-phone device without querying the user. On the other hand, if the share request regarding shared data is from an unregistered call counterpart, the user is queried as to whether or not to allow sharing. It is thereby possible to automatically share only shared data from a call counterpart known in advance to be trusted.

The above description was given for an instance in which shared data is transmitted from the communication-counterpart video-phone device to the user-side video-phone device. However, an arrangement is also possible in which the shared data is held by the user-side video-phone device, and a sharing request asking shared data to be shared is made by the communication-counterpart video-phone device to the user-side video-phone device.

In addition, although the above description was given for an instance in which shared data is transmitted and received directly between the communication-counterpart video-phone device and the user-side video-phone device, the present invention is not limited to this embodiment. For example, an arrangement is also possible in which the shared data is transmitted to a server (not shown) and a share request signal is transmitted to a bathroom television device of the call counterpart, and when sharing is allowed by a television device 10 of the call counterpart, the shared data is acquired from the server and displayed from the television device.

The present application claims priority over JP-A 2011-260514 filed on 29 Nov. 2011, and the entire contents thereof are incorporated herein by reference.

### KEY TO SYMBOLS

100 Video-phone device
101 Wired LAN
102 IP telephone router
103 Broadband router
104 Gateway
105 IP telephone network
106 Internet
107 PSTN network
108 Subscriber telephone device
110 Control unit
111 Communication control means
112 Audio signal processing means
113 Image/video signal processing means
114 Display control means
115 Image editing means
116 Data control means
117 Registering means
120 Microphone
130 Speaker
140 Camera
150 Display unit
160 Input unit
170 Recording unit

1. A video-phone device for exchanging shared data with a call counterpart, the video-phone device comprising communication control means for determining, once a reception request or a transmission request regarding said shared data has been received, whether or not said reception request or transmission request satisfies a predetermined condition, and receiving said shared data from said call counterpart or transmitting said shared data to said call counterpart only when said predetermined condition is satisfied.

2. The video-phone device according to claim 1, wherein the video-phone device is further provided with a recording unit for recording call counterparts with which the exchange of said shared data is allowed by said video-phone device, said communication control means receives said shared data from said call counterpart or transmits said shared data to said call counterpart only when, as said predetermined condition, the call counterpart which has transmitted said reception request or transmission request is a call counterpart with which the exchanging of said shared data is allowed.

3. The video-phone device according to claim 2, wherein the video-phone device is further provided with registering means for registering the call counterparts in said recording unit, said registering means registers, as a call counterpart with which the exchanging of said shared data is allowed, a call counterpart with which said communication control means has exchanged said shared data.

4. The video-phone device according to claim 1, wherein said communication control means receives said shared data from said call counterpart or transmits said shared data to said call counterpart only when, as said predetermined condition, the call counterpart which has transmitted the reception request or the transmission request regarding said shared data is a billing party.

5. The video-phone device according to claim 1, wherein said communication control means checks with the user whether or not to allow transmission or reception of said shared data in a case where the reception request or the transmission request regarding said shared data does not satisfy said predetermined condition.

6. The video-phone device according to claim 1, wherein the communication control means allows reception of said shared data from said call counterpart or transmission of said shared data to said call counterpart in a case where, once the exchanging of shared data has been allowed during the same call, a transmission request or a reception request regarding said shared data is again received.
